(19) United States
(12) Patent Application Publication
(10) Pub. No.: US 2026/0149531 A1
(43) Pub. Date: May 28, 2026

(54) DYNAMIC INDICATION OF BLIND DECODING CANDIDATES FOR AGGREGATION LEVELS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/957,517

(22) Filed: Nov. 22, 2024

(51) Int. Cl. H04L 1/00; H04W 8/24

(52) U.S. Cl. CPC H04L 1/0038; H04W 8/24

(57) ABSTRACT

Methods, systems, and devices for wireless communications are described. A user equipment (UE) may transmit a capability message that may indicate a capability of the UE to support dynamic change of control channel blind decoding candidates. The UE may receive, in accordance with the capability message, an indication that a quantity of control channel blind decoding candidates in a slot to be monitored by the UE may be changed, where the slot may have a slot position in a frame and the indication may be based on the slot position. The UE may monitor, in the slot and in accordance with the indication, the quantity of control channel blind decoding candidates for one or more control channels.

### FIELD OF TECHNOLOGY

The following relates to wireless communications, including dynamic indication of blind decoding candidates for aggregation levels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability message that indicates a capability of the UE to support dynamic change of control channel blind decoding candidates, receiving, in accordance with the capability message, an indication that a quantity of control channel blind decoding candidates in a slot to be monitored by the UE is changed, where the slot has a slot position in a frame and where the indication is based on the slot position, and monitoring, in the slot and in accordance with the indication, the quantity of control channel blind decoding candidates for one or more control channels.

A UE for wireless communications is described. The UE may include one or more memories storing processor executable code, and one or more processors coupled with the one or more memories. The one or more processors may individually or collectively be operable to execute the code to cause the UE to transmit a capability message that indicates a capability of the UE to support dynamic change of control channel blind decoding candidates, receive, in accordance with the capability message, an indication that a quantity of control channel blind decoding candidates in a slot to be monitored by the UE is changed, where the slot has a slot position in a frame and where the indication is based on the slot position, and monitor, in the slot and in accordance with the indication, the quantity of control channel blind decoding candidates for one or more control channels.

Another UE for wireless communications is described. The UE may include means for transmitting a capability message that indicates a capability of the UE to support dynamic change of control channel blind decoding candidates, means for receiving, in accordance with the capability message, an indication that a quantity of control channel blind decoding candidates in a slot to be monitored by the UE is changed, where the slot has a slot position in a frame and where the indication is based on the slot position, and means for monitoring, in the slot and in accordance with the indication, the quantity of control channel blind decoding candidates for one or more control channels.

A non-transitory computer-readable medium storing code for wireless communications is described. The code may include instructions executable by one or more processors to transmit a capability message that indicates a capability of the UE to support dynamic change of control channel blind decoding candidates, receive, in accordance with the capability message, an indication that a quantity of control channel blind decoding candidates in a slot to be monitored by the UE is changed, where the slot has a slot position in a frame and where the indication is based on the slot position, and monitor, in the slot and in accordance with the indication, the quantity of control channel blind decoding candidates for one or more control channels.

Some examples of the method, UEs, and non-transitory computer-readable medium described herein may further include operations, features, means, or instructions for determining the quantity of control channel blind decoding candidates in accordance with the indication and based on an aggregation level associated with communication via the one or more control channels.

In some examples of the method, UEs, and non-transitory computer-readable medium described herein, determination of the quantity of control channel blind decoding candidates may be further based on a slot associated with the aggregation level and the communication via the one or more control channels.

In some examples of the method, UEs, and non-transitory computer-readable medium described herein, determination of the quantity of control channel blind decoding candidates may be further based on a time division duplexing (TDD) pattern associated with the aggregation level and the communication via the one or more control channels.

In some examples of the method, UEs, and non-transitory computer-readable medium described herein, determination of the quantity of control channel blind decoding candidates may be further based on a sub-band full duplexing (SBFD) pattern associated with the aggregation level and the communication via the one or more control channels.

In some examples of the method, UEs, and non-transitory computer-readable medium described herein, determination of the quantity of control channel blind decoding candidates may be further based on a terrestrial network (TN) slot pattern or a non-terrestrial network (NTN) slot pattern associated with the aggregation level and the communication via the one or more control channels.

Some examples of the method, UEs, and non-transitory computer-readable medium described herein may further include operations, features, means, or instructions for receiving control signaling that indicates one or more mappings, the one or more mappings including a mapping associated with the indication, where the mapping associated with the indication maps the quantity of control channel blind decoding candidates with an aggregation level associated with the slot position, where the slot position in the frame may be in accordance with a TDD pattern.

Some examples of the method, UEs, and non-transitory computer-readable medium described herein may further include operations, features, means, or instructions for transmitting a message indicating a UE-preferred mapping of the one or more mappings, where receiving the indication may be based on transmitting the message.

In some examples of the method, UEs, and non-transitory computer-readable medium described herein, the indication includes an index of the mapping of the one or more mappings.

In some examples of the method, UEs, and non-transitory computer-readable medium described herein, the indication may be based on one or more conditions associated with a serving cell, the one or more conditions including a distance of the UE from a network entity of the serving cell, a network load, a speed of the UE within the serving cell, a quality of service threshold, a reliability threshold, or any combination thereof.

In some examples of the method, UEs, and non-transitory computer-readable medium described herein, the indication may be received in a media access control-control element (MAC-CE) or a downlink control information (DCI) message.

In some examples of the method, UEs, and non-transitory computer-readable medium described herein, the indication may be a first indication and the method, apparatuses, and non-transitory computer-readable medium may include further operations, features, means, or instructions for receiving a second indication that the quantity of control channel blind decoding candidates in a second slot to be monitored by the UE may be changed to a second quantity of control channel blind decoding candidates, where the second slot may have a second slot position in a frame and where the second indication may be based on the second slot position and monitoring, in the second slot and in accordance with the second indication, the second quantity of control channel blind decoding candidates for one or more second control channels.

A method for wireless communications by a network entity is described. The method may include obtaining a capability message that indicates a capability of a UE to support dynamic change of control channel blind decoding candidates, outputting, in accordance with the capability message, an indication that a quantity of control channel blind decoding candidates in a slot to be monitored by the UE is changed, where the slot has a slot position in a frame and where the indication is based on the slot position, and outputting, in the slot and in accordance with the indication, the quantity of control channel blind decoding candidates for one or more control channels.

A network entity for wireless communications is described. The network entity may include one or more memories storing processor executable code, and one or more processors coupled with the one or more memories. The one or more processors may individually or collectively be operable to execute the code to cause the network entity to obtain a capability message that indicates a capability of a UE to support dynamic change of control channel blind decoding candidates, output, in accordance with the capability message, an indication that a quantity of control channel blind decoding candidates in a slot to be monitored by the UE is changed, where the slot has a slot position in a frame and where the indication is based on the slot position, and output, in the slot and in accordance with the indication, the quantity of control channel blind decoding candidates for one or more control channels.

Another network entity for wireless communications is described. The network entity may include means for obtaining a capability message that indicates a capability of a UE to support dynamic change of control channel blind decoding candidates, means for outputting, in accordance with the capability message, an indication that a quantity of control channel blind decoding candidates in a slot to be monitored by the UE is changed, where the slot has a slot position in a frame and where the indication is based on the slot position, and means for outputting, in the slot and in accordance with the indication, the quantity of control channel blind decoding candidates for one or more control channels.

A non-transitory computer-readable medium storing code for wireless communications is described. The code may include instructions executable by one or more processors to obtain a capability message that indicates a capability of a UE to support dynamic change of control channel blind decoding candidates, output, in accordance with the capability message, an indication that a quantity of control channel blind decoding candidates in a slot to be monitored by the UE is changed, where the slot has a slot position in a frame and where the indication is based on the slot position, and output, in the slot and in accordance with the indication, the quantity of control channel blind decoding candidates for one or more control channels.

In some examples of the method, network entities, and non-transitory computer-readable medium described herein, the indication, combined with an aggregation level associated with communication via the one or more control channels, may be indicative of the quantity of control channel blind decoding candidates.

In some examples of the method, network entities, and non-transitory computer-readable medium described herein, the indication, further combined with a slot associated with the aggregation level, a TDD pattern associated with the aggregation level, a SBFD pattern associated with the aggregation level, a TN slot pattern associated with the aggregation level, a NTN slot pattern associated with the aggregation level, or any combination thereof and the communication via the one or more control channels, may be indicative of the quantity of control channel blind decoding candidates.

Some examples of the method, network entities, and non-transitory computer-readable medium described herein may further include operations, features, means, or instructions for outputting control signaling that indicates one or more mappings, the one or more mappings including a mapping associated with the indication, where the mapping associated with the indication maps the quantity of control channel blind decoding candidates with an aggregation level associated with the slot position, where the slot position in the frame may be in accordance with a TDD pattern.

Some examples of the method, network entities, and non-transitory computer-readable medium described herein may further include operations, features, means, or instructions for obtaining a message indicating a UE-preferred mapping of the one or more mappings, where receiving the indication may be based on transmitting the message.

In some examples of the method, network entities, and non-transitory computer-readable medium described herein, the indication includes an index of the mapping of the one or more mappings.

In some examples of the method, network entities, and non-transitory computer-readable medium described herein, the indication may be based on one or more conditions associated with a serving cell that includes the network entity, the one or more conditions including a distance of the UE from the network entity, a network load, a speed of the UE within the serving cell, a quality of service threshold, a reliability threshold, or any combination thereof.

In some examples of the method, network entities, and non-transitory computer-readable medium described herein, the indication may be output in a MAC-CE or a DCI message.

In some examples of the method, network entities, and non-transitory computer-readable medium described herein, the indication may be a first indication and the method, apparatuses, and non-transitory computer-readable medium may include further operations, features, means, or instructions for outputting a second indication that the quantity of control channel blind decoding candidates in a second slot to be monitored by the UE may be changed to a second quantity of control channel blind decoding candidates, where the second slot may have a second slot position in a frame and where the second indication may be based on the second slot position and outputting, in the second slot and in accordance with the second indication, one or more second control channels, the one or more second control channels associated with the second quantity of control channel blind decoding candidates.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support dynamic indication of blind decoding candidates for aggregation levels in accordance with one or more aspects of the present disclosure.

FIG. 3 shows an example of a control channel element (CCE) diagram that supports dynamic indication of blind decoding candidates for aggregation levels in accordance with one or more aspects of the present disclosure.

FIGS. 4A and 4B show examples of blind decoding candidate mappings that supports dynamic indication of blind decoding candidates for aggregation levels in accordance with one or more aspects of the present disclosure.

FIG. 5 shows an example of a process flow that supports dynamic indication of blind decoding candidates for aggregation levels in accordance with one or more aspects of the present disclosure.

FIGS. 6 and 7 show block diagrams of devices that support dynamic indication of blind decoding candidates for aggregation levels in accordance with one or more aspects of the present disclosure.

FIG. 8 shows a block diagram of a communications manager that supports dynamic indication of blind decoding candidates for aggregation levels in accordance with one or more aspects of the present disclosure.

FIG. 9 shows a diagram of a system including a device that supports dynamic indication of blind decoding candidates for aggregation levels in accordance with one or more aspects of the present disclosure.

FIGS. 10 and 11 show block diagrams of devices that support dynamic indication of blind decoding candidates for aggregation levels in accordance with one or more aspects of the present disclosure.

FIG. 12 shows a block diagram of a communications manager that supports dynamic indication of blind decoding candidates for aggregation levels in accordance with one or more aspects of the present disclosure.

FIG. 13 shows a diagram of a system including a device that supports dynamic indication of blind decoding candidates for aggregation levels in accordance with one or more aspects of the present disclosure.

FIGS. 14 and 15 show flowcharts illustrating methods that support dynamic indication of blind decoding candidates for aggregation levels in accordance with one or more aspects of the present disclosure.

### DETAILED DESCRIPTION

In some wireless communications systems, a user equipment (UE) may perform blind decoding on physical downlink control channel (PDCCH) candidates (e.g., downlink control channel candidates) in an effort to receive a PDCCH (e.g., downlink control channel). That is, the UE may blindly decode PDCCH candidates in order to receive a PDCCH sent at one or more of the PDCCH candidates. However, PDCCH blind decoding may be limited for multiple reasons, which may lead to PDCCH blocking (e.g., the UE may not receive a PDCCH, leading to a failure to schedule a physical downlink shared channel (PDSCH) or a physical uplink shared channel (PUSCH)). For example, a network entity may transmit downlink control information (DCI) associated with (e.g., scheduling) uplink transmissions (e.g., uplink DCI) and DCI associated with (e.g., scheduling) downlink transmissions (e.g., downlink DCI) via PDCCH. In some cases, the network entity may transmit uplink DCI and downlink DCI in the same PDCCH instance. The UE may be able to receive one DCI, which may result in PDCCH blocking of the second DCI or the conflicting DCI. Additionally, or alternatively, the network entity may schedule multiple UEs at once. There may be a limited quantity of control channel elements (CCEs) that the network entity may schedule PDCCHs on. That is, the UE may monitor CCEs being used for a separate UE (e.g., a busy CCE). Thus, the UE may not receive a PDCCH during a PDCCH blind decoding candidate associated with monitoring the busy CCEs.

To mitigate PDCCH blocking from conflicting uplink DCI and downlink DCI, as well as busy CCEs, the UE may support multiple PDCCH blind decoding candidates, increasing a likelihood that the UE will successfully receive relevant PDCCHs. However, the UE may be configured with a threshold quantity of PDCCH blind decoding candidates, which may support power saving at the UE, among other benefits. That is, the UE may perform blind decoding on, at most, a threshold quantity of candidates within a slot for a serving cell. In some implementations, the UE may be configured to statically distribute PDCCH candidates across slots. However, PDCCH blocking may be variable across slots. The UE may not support enough PDCCH blind decoding candidates across some slots with high block rates, while the UE may perform excessive blind decoding on slots with low block rates. In particular, if some condition related to the UE changes (e.g., location, speed, network load), the static PDCCH blind decoding candidate configuration may not suffice. For example, the UE may operate with some aggregation level, which may be related to the location of the UE within a cell. A low aggregation level (e.g., near cell UE) may correspond to a lower quantity of PDCCH blind decoding candidates than a high aggregation level (e.g., far cell UE), but a static configuration may not reflect these differences.

The techniques described herein support a UE in indicating a capability to maintain mappings (e.g., tables) between PDCCH blind decoding candidate quantities and aggregation levels, such that a network entity may dynamically indicate a change in a PDCCH blind decoding candidate quantity. For example, the UE may indicate a capability to support dynamic changes in PDCCH blind decoding candidates. The network entity may configure the UE, via control signaling, with multiple tables or mappings between quantities of PDCCH blind decoding candidates and different aggregation levels. In some implementations, the tables or mappings may include a quantity of PDCCH blind decoding candidates for different aggregation levels within each slot of a cycle. The network entity may, depending on some condition or change in conditions within a serving cell, output an indication that a quantity of control channel candidates at the UE is changed. For example, the network entity may output an indication of an index corresponding to a table or mapping, and the UE may use the indicated table or mapping to determine a quantity of control channel candidates to monitor based on an aggregation level at the UE and, in some cases, a slot. Dynamic indications of a quantity of blind decoding candidates may reduce PDCCH blocking and improve performance, among other advantages.

Aspects of the disclosure are initially described in the context of wireless communications systems, CCE diagrams, blind decoding candidate mappings, and process flows. Aspects of the disclosure are further illustrated by and described with reference to apparatus diagrams, system diagrams, and flowcharts that relate to dynamic indication of blind decoding candidates for aggregation levels.

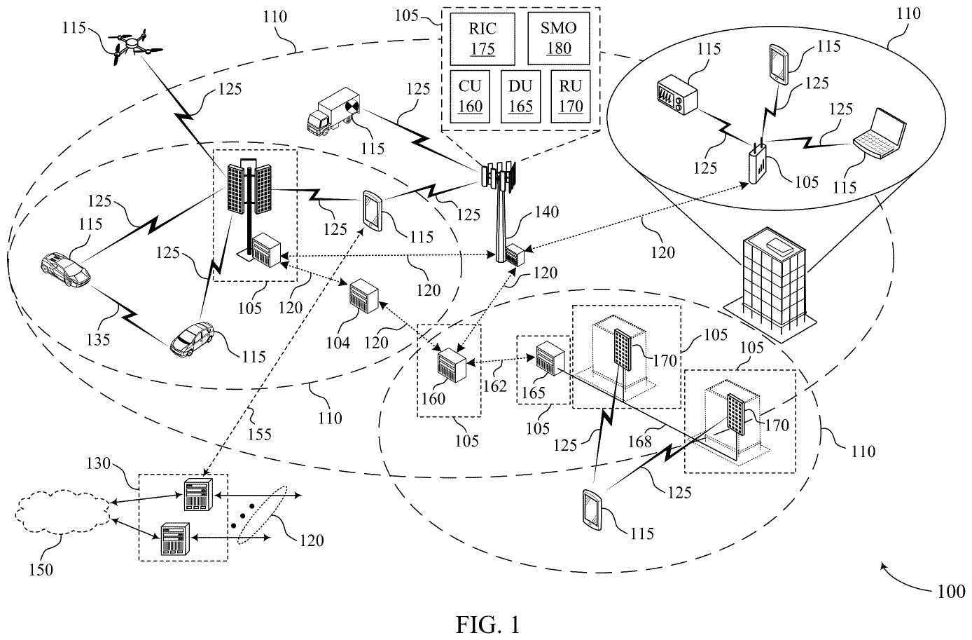

FIG. 1 shows an example of a wireless communications system 100 that supports dynamic indication of blind decoding candidates for aggregation levels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support dynamic indication of blind decoding candidates for aggregation levels as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., CCEs) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, a UE 115 may perform blind decoding on PDCCH candidates (e.g., downlink control channel candidates) in an effort to receive a PDCCH (e.g., downlink control channel). That is, the UE 115 may blindly decode PDCCH candidates in order to receive a PDCCH sent at one or more of the PDCCH candidates. In some cases, PDCCH blind decoding may be limited, which may lead to PDCCH blocking (e.g., the UE may not receive a PDCCH, leading to a failure to schedule a PDSCH or a PUSCH). For example, a network entity 105 may transmit DCI associated with (e.g., scheduling) uplink transmissions (e.g., uplink DCI) and DCI associated with (e.g., scheduling) downlink transmissions (e.g., downlink DCI) via PDCCH. In some cases, the network entity 105 may transmit uplink DCI and downlink DCI in the same PDCCH instance. The UE 115 may be able to receive one DCI, which may result in PDCCH blocking of the second DCI, or the conflict DCI. Additionally, or alternatively, the network entity 105 may schedule multiple UEs 115 at once. There may be a limited quantity of CCEs that the network entity 105 may schedule PDCCHs on. That is, the UE 115 may monitor CCEs being used for a separate UE 115 (e.g., a busy CCE). Thus, the UE 115 may not receive a PDCCH during a PDCCH blind decoding candidate associated with monitoring the busy CCEs.

To mitigate PDCCH blocking from conflicting uplink DCI and downlink DCI, as well as busy CCEs, the UE 115 may support multiple PDCCH blind decoding candidates, increasing a likelihood that the UE 115 will successfully receive relevant PDCCHs. However, the UE 115 may be configured with a threshold quantity of PDCCH blind decoding candidates, which may support power saving at the UE 115, among other benefits. That is, the UE 115 may perform blind decoding on, at most, a threshold quantity of candidates within a slot for a serving cell. In some implementations, the UE 115 may be configured to statically distribute PDCCH candidates across slots. However, PDCCH blocking may be variable across slots. The UE 115 may not support enough PDCCH blind decoding candidates across some slots with high block rates, while the UE 115 may perform excessive blind decoding on slots with low block rates. In particular, if some condition related to the UE 115 changes (e.g., location, speed, network load), the static PDCCH blind decoding candidate configuration may not suffice. For example, the UE 115 may operate with some aggregation level, which may be related to the location of the UE 115 within a cell. A low aggregation level (e.g., near cell UE 115) may correspond to a lower quantity of PDCCH blind decoding candidates than a high aggregation level (e.g., far cell UE 115), but a static or semi-static configuration may not reflect these differences.

In some wireless communications systems 100, a UE 115 may indicate a capability to maintain mappings (e.g., tables) between PDCCH blind decoding candidate quantities and aggregation levels, such that a network entity 105 may dynamically indicate a change in a PDCCH blind decoding candidate quantity. For example, the UE 11 may indicate a capability to support dynamic changes in PDCCH blind decoding candidates. The network entity 105 may configure the UE 115, via control signaling, with multiple tables or mappings between quantities of PDCCH blind decoding candidates and different aggregation levels. In some implementations, the tables or mappings may include a quantity of PDCCH blind decoding candidates for different aggregation levels within each slot of a cycle. The network entity 105 may, depending on some condition or change in conditions within a serving cell, output an indication that a quantity of control channel candidates at the UE 115 is changed. For example, the network entity 105 may output an indication of an index corresponding to a table or mapping, and the UE 115 may use the indicated table or mapping to determine a quantity of control channel candidates to monitor based on an aggregation level at the UE 115 and, in some cases, a slot. Dynamic indications of a quantity of PDCCH blind decoding candidates may reduce PDCCH blocking and improve performance, among other advantages.

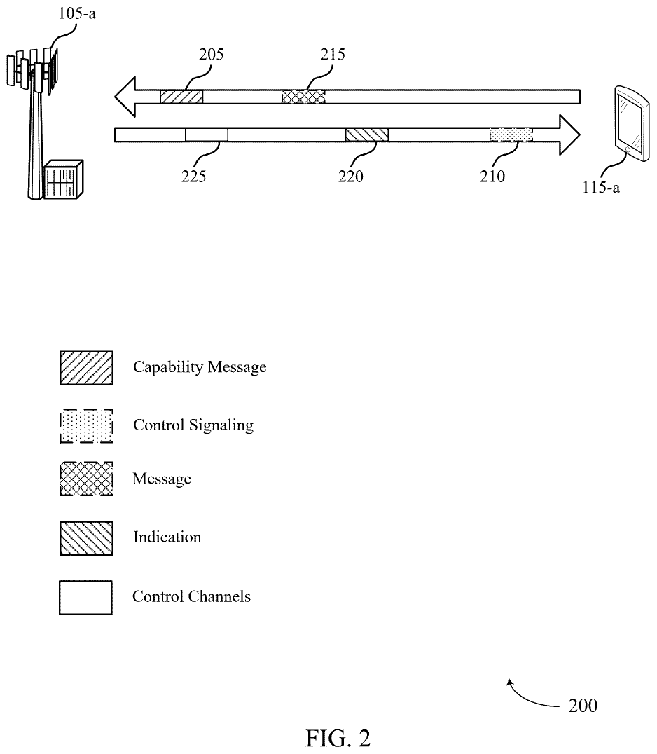

FIG. 2 shows an example of a wireless communications system 200 that supports dynamic indication of blind decoding candidates for aggregation levels in accordance with one or more aspects of the present disclosure. The wireless communications system 200 may implement, or be implemented by, aspects of the wireless communications system 100. For example, the wireless communications system 200 may include one or more network entities 105 and UEs 115, including at least the network entity 105-a and the UE 115-a, which may be examples of corresponding devices as described herein, including with reference to FIG. 1. The techniques described herein in the context of the wireless communications system 200 may support the network entity 105-a dynamically indicating a change in a quantity of PDCCH blind decoding candidates based on an indicated capability of the UE 115-a.

In some wireless communications systems (e.g., 5G networks, NR networks), PDCCH blocking may be associated with limitations on a quantity of CCEs and limitations on quantities of blind decoding candidates for the UE 115-a. That is, the UE 115-a may fail to receive control channels 225 (e.g., PDCCH blocking) based on limitations, and conditions for a serving cell. In some implementations, a slot may be used to transmit both PDCCHs (control channels 225) and data (e.g., shared channels, PDSCH, PUSCH). A first quantity of symbols at the beginning of the slot may be used for transmitting a PDCCH, while the rest of the symbols may be used for transmitting the data. However, in some cases, despite allocation of physical resource blocks (PRBs) for transmitting data, which may be related to a quantity of symbols within a slot, there may still be PDCCH blocking. For example, transmitting data may use 30% of PRBs (e.g., hot spot, busy UE 115-a) during some period, which may be correlated with high PDCCH blocking during that period. That is, PDCCH blocking may be due to conflict within a slot. It may be beneficial to improve CCE allocation and PDCCH blind decoding assignments for the UE 115-a to reduce PDCCH blocking.

In some implementations, a rate of PDCCH blocking across multiple slots may be highly variable, even if a quantity of connected UEs 115 may not change across the slots. That is, an average rate of PDCCH blocking (e.g., PDCCH blocking rate) across slots may not be representative of all slots. Assuming an average PDCCH block rate across multiple slots may not reflect actual slot conditions, which may result in greater PDCCH block rates, increased latency, and other disadvantages (e.g., issues in deployment scenarios). For example, in a first slot, a PDCCH blocking rate may be zero (e.g., 0%), but in the next slot, the rate PDCCH blocking rate may be much higher (e.g., 65%).

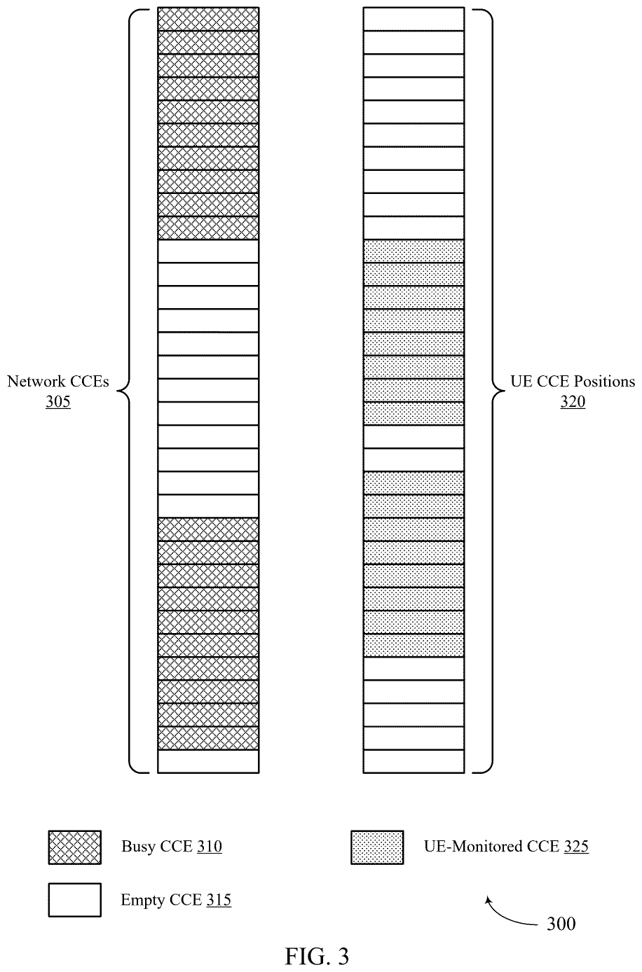

Some wireless communications systems 200 may be NR networks. In some cases, an NR network may have different limitations and parameters associated with the blind decoding of PDCCH candidates than other wireless communications systems 200, such as LTE networks. For example, an NR network may maintain a threshold of CCEs (e.g., 16 CCEs) within a control resource set (CORESET) that may be greater than a threshold of CCEs within a CORESET for an LTE network (e.g., 8 CCEs). That is, a CORESET may be divided into a set of resource element groups (REGs), which may be mapped to a set of CCEs of a quantity of CCEs. The set of CCEs may be associated with different search spaces, which may correspond to PDCCH candidates. The quantity of CCEs in the set of CCEs may differ based on a type of network. Additionally, or alternatively, a CCE in an NR network may have a greater quantity of resource elements (REs) (e.g., 72 REs), than a CCE in an LTE network (e.g., 36 REs). Additionally, or alternatively, an NE network may support a demodulation reference signal (DMRS) control element (CE) limitation for the UE 115-a. In some cases, DCI or DMRS may be mapped to REs for transmission. Additionally, or alternatively, a network entity 105-a for an NR network may schedule multiple UEs 115, which may result in inter-UE blocking. The inter-UE blocking may be a result of consecutive CCE allocation across multiple UEs 115, such that CCEs may be available for the UE 115-a to monitor, but may be used for transmissions to another UE 115 (e.g., busy CCEs), as described further with reference to FIG. 3.

Additionally, or alternatively, an NR network may use static symbols with PDCCH rate matching for transmitting PDCCH, while an LTE network may use a control format indicator (CFI) to indicate dynamic symbols for transmitting PDCCH. That is, an NR network may puncture, shorten, or repeat bits of the PDCCH to fit into static symbols. Additionally, or alternatively, an NR network may implement polar coding, which may result in large or high quantities of padding bits for a fixed transport block (TB) size (e.g., 140 bits), as compared to an LTE network, which may implement different PDCCH channel coding schemes. For example, an encoded DCI may include a cyclic redundancy check (CRC) attachment (e.g., 24 bit CRC attachment), a CRC interleaver, a radio network temporary identifier (RNTI) encoding associated with the RNTI, polar coding, rate matching (e.g., via puncturing, shortening, repetitions of the DCI payload (e.g., k-bit payload)), scrambling, quadrature phase shift keying (QPSK), or any combination thereof. The DCI and associated DMRS may be mapped to REs and transmitted to the UE 115-a.

Additionally, or alternatively, a wireless communication system 200, such as an NR network, may support blind decoding limitations at the UE 115-a. In some implementations, a quantity of PDCCH blind decoding candidates may be limited within a serving cell in order to reduce power consumption and complexity at the UE 115-a, among other benefits. For example, a downlink DCI and an uplink DCI may occur in the same PDCCH instance. The UE 115-a may decode one of the DCI, and the other may be blocked (e.g., PDCCH blocking). If the UE 115-a monitors an indefinite quantity of PDCCH blind decoding candidates, expecting to receive the PDCCH that may have been blocked, the UE 115-a may expend power and time when the PDCCH may not be retransmitted. Limiting the quantity of PDCCH blind decoding candidates may limit the power and time expended at the UE 115-a for blind decoding. In some cases, a threshold quantity of PDCCH blind decoding candidates

$$( e . g . , {M}_{PDCCH}^{max , slot , μ} )$$

may be defined based on a configuration. For example, Table 1 may indicate a mapping between a parameter (e.g., μ) associated with a sub-carrier spacing (SCS) configuration for a downlink bandwidth part (BWP), which may correspond to a duration of a slot, and threshold quantities of PDCCH blind decoding candidates.

TABLE 1
Example of Mapping between μ and Threshold
Quantities of PDCCH Blind Decoding Candidates

| | Threshold Quantity of Monitored PDCCH candidates |
|---|---|
| μ | per slot and per serving cell (M_{PDCCH}^{max, slot, μ}) |
| 0 | 44 |
| 1 | 36 |
| 2 | 22 |
| 3 | 20 |

For example, μ=1 (e.g., sub6TDD) may correspond to a sub-carrier spacing of 30 kHz, which may be associated with a slot duration of one millisecond. The UE 115-a may monitor and blindly decode thirty six PDCCH blind decoding candidates within the slot. If the UE 115-a exceeds thirty six monitored PDCCH blind decoding candidates, the UE 115-a may stop monitoring and decoding PDCCH candidates. In some cases, the UE 115-a may miss a PDCCH due to stopping monitoring, increasing a PDCCH blocking rate.

In some implementations, the network entity 105-a may schedule multiple UEs 115 across CCEs. The UE 115-a may monitor CCEs that may be used for PDCCHs for other UEs 115 (e.g., busy CCEs). In some cases, such as if monitoring busy CCEs, the UE 115-a may not receive a PDCCH in the PDCCH blind decoding candidate. Increasing a quantity of PDCCH blind decoding candidates may increase the chance that the UE 115-a may receive the PDCCH (e.g., successful CCE allocation), but may be limited by the threshold quantity of PDCCH blind decoding candidates. A quantity of blind decoding candidates may also be based on an aggregation level at the UE 115-a. The aggregation level may determine the quantity of CCEs in a PDCCH, or the quantity of CCEs to monitor during a monitoring occasion. A higher aggregation level may correspond to a higher quantity of CCEs for a PDCCH. If the UE 115-a has a high aggregation level, such as a UE 115-a that may be located farther away in a serving cell (e.g., far cell UE 115-a), the UE 115-a may monitor a greater quantity of CCEs than a UE 115 with a lower aggregation level. For example, the UE 115-a in the far cell may implement a high aggregation level to support a low coding rate. In some cases, the conditions of the serving cell or conditions associated with the UE 115-a, such as the location of the UE 115-a, may change, but the static configuration of the quantity of PDCCH blind decoding candidates configuration may not change, which may result in the UE 115-a operating with a quantity of blind decoding candidates that may not reflect the current conditions of the UE 115-a. Instead, the network entity 105-a may define multiple different quantities of blind decoding candidates for each aggregation level at the UE 115-a, and may dynamically indicate changes in the quantities of PDCCH blind decoding candidates.

In some implementations, such as TDD systems, multiple slots may form a pattern, or cycle. Each slot may be used for a defined purpose, such as slots for receiving downlink transmissions (e.g., PDCCH), slots for transmitting uplink transmissions, and switching slots for moving between downlink and uplink slots. Downlink slots may receive DCI, such as downlink DCI and uplink DCI. In some cases, slots may receive downlink DCI and may not receive uplink DCI. These slots may have low or zero PDCCH blocking rates, as the downlink DCI may not conflict with an uplink DCI. However, some slots, such as a slot before a switching slot, may receive uplink DCI and downlink DCI. The slots may be defined based on configured parameters (e.g., k0 and k2), which may define a quantity of slots after receiving a DCI that a shared channel may be communicated. For example, a first parameter (e.g., k0) may be associated with downlink DCI and may be zero, indicating that the slot may contain downlink data, as well as the downlink DCI. A second parameter (e.g., k2) may be associated with uplink DCI and may be two, indicating that the UE 115-a may perform uplink transmissions in a slot two slots after the slot in which the uplink DCI may be received. Slots which may contain both uplink DCI and downlink DCI may be highly congested, which may be associated with higher PDCCH blocking rates. However, in slots with downlink DCI and no uplink DCI, the UE 115-a may monitor for downlink DCI and may not use PDCCH blind decoding attempts for uplink DCI. That is, the UE 115-a may monitor the quantity of PDDCH blind decoding candidates for the downlink DCI, rather than using some of the quantity of PDCCH blind decoding candidates to monitor doe the uplink DCI. This may act as effectively doubling a quantity of PDCCH blind decoding candidates for a downlink DCI. As such, the network entity 105-a may assign more UEs 115, using downlink DCI, during the downlink-only slots based on the increased likelihood that the UEs 115 may receive the PDCCH. Thus, it may be beneficial to also indicate a quantity of PDCCH blind decoding candidates for each slot of a pattern (e.g., TDD pattern). In some implementations, the network entity 105-a may define multiple different quantities of blind decoding candidates for each aggregation level at the UE 115-a and for each slot of a TDD pattern at the UE 115-a, and may dynamically indicate changes in the quantities of PDCCH blind decoding candidates.

In some implementations, a TDD carrier may support a sub-band full duplexing (SBFD) pattern. In some cases, the network entity 105-a may configure the UE 115-a with a cell-specific configuration indicating time and frequencies associated with SBFD sub-bands. In some examples, SBFD symbols may be configured for downlink slots. In some example, SBFD symbols may include flexible symbols (e.g., symbols that may support uplink and downlink communication) configured in a TDD pattern (e.g., TDD-UL-DL-ConfigCommon). SBFD symbols may start and end at any symbol within a slot and may span multiple symbols. One slot may include SBFD symbols and non-SBFD symbols. In some examples, SBFD symbols may be configured consecutively within a TDD pattern (e.g., TDD-UL-DL pattern period), such that the SBFD symbols may be grouped together within a slot. In some examples, SBFD symbols may be configured across one or more patterns. For example, if two TDD patterns are configured, the SBFD symbols may be configured across both patterns or across one of the patterns. In some cases, SBFD symbols within a slot may affect the quantity of blind decoding candidates indicated within the slot.

In some implementations, a terrestrial network (TN) and a non-terrestrial network (NTN) may use defined slot patterns. For example, a remote radio unit, such as a satellite, may form part of an NTN infrastructure, which may include a feeder link (e.g., a link between a network entity and a remote radio unit, such as a satellite). An NTN network may account for a pre-compensation of time and frequency resources for communication and may include enhancements to timing relationships due to an increase round trip time (RTT) for communications, as compared to a TN. For example, uplink transmissions from a UE may be transmitted to a network entity, via a satellite, with a timing advance, such that the uplink transmissions may be received at the network entity simultaneously with the downlink transmissions at the network entity. This may result in a different slot pattern for an NTN than may be included in a TN. In some cases, implementing an NTN or a TN may affect the quantity of blind decoding candidates indicated within a slot.

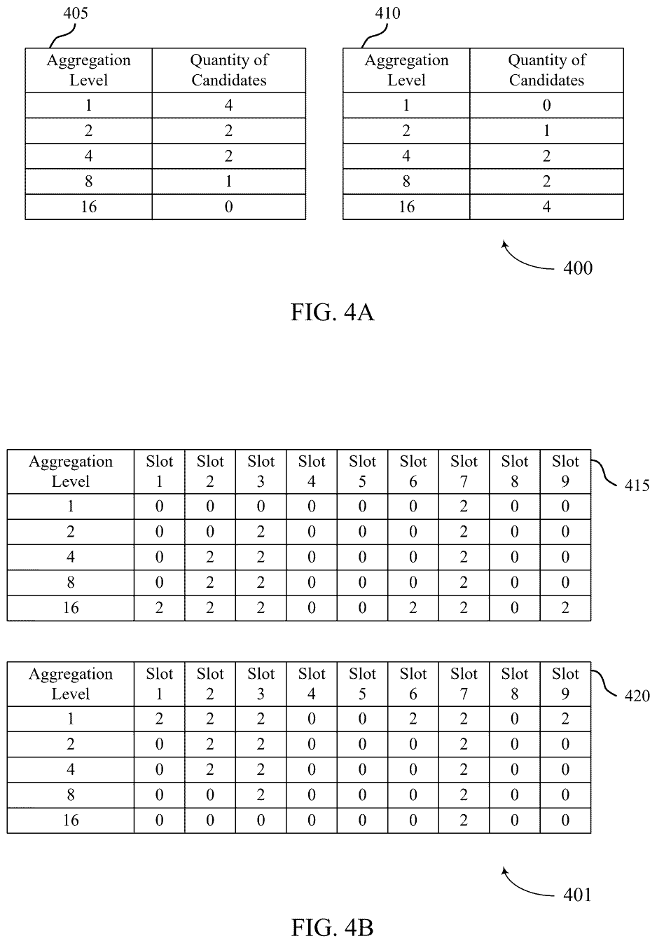

In order to support the dynamic indication of a change in a quantity of PDCCH blind decoding candidates, the UE 115-a may transmit a capability message 205. The capability message may indicate that the UE 115-a may support dynamic indication of the quantity of blind decoding candidates. The network entity 105-a may transmit control signaling 210, which may configure or reconfigure the UE 115-a with different mappings between aggregation levels and quantities of blind decoding candidates, as described further at FIG. 4A. In some cases, the mapping may be on a per-slot basis, as described further with reference to FIG. 4B. For example, the network entity 105-a may configure the UE 115-a with multiple tables, each with a different index, mapping between these parameters. The configuration of tables may override or reconfigure a static configuration of a quantity of blind decoding candidates for an aggregation level at the UE 115-a. In some cases, a threshold quantity of uplink sub-bands for SBFD operation in a SBFD symbol within a TDD carrier may be one. The uplink sub-band may be located at a side or in a middle part of a carrier. In some examples, the SBFD frequency patterns may include a downlink-uplink (DU) pattern, a D-U-D pattern, or a U-D pattern. In some examples, the sub-band frequency resources may be the same across different SBFD symbols within the TDD carrier. In some examples, a common resource block (CRB) grid may indicate a frequency location of a cell-specific uplink sub-band and related downlink sub-bands, which may be associated with the SBFD symbols. In some examples, a resource block (RB)-level granularity may be supported for a semi-static indication of the SBFD sub-band frequency location, which may, in some cases, be based on the size of the sub-band or a guard-band.

In some implementations, the UE 115-a may indicate a mapping via a message 215. For example, the UE 115-a may indicate a mapping (e.g., desired, preferred mapping) based on some conditions at the UE 115-a, such as the location of the UE 115-a, a speed of the UE 115-a, or other conditions associated with the serving cell. Evaluating these conditions may be based on some capability of the UE 115-a to perform and analyze measurements. For example, a far-cell UE 115-a may indicate, via message 215, a mapping that offers higher quantities of PDCCH blind decoding candidates for higher aggregation levels. The network entity 105-a may send an indication 220 of a mapping. The indication may be transmitted via DCI or media access control-control element (MAC-CE), and may be an example of a dynamic indication of a change in the quantity of blind decoding candidates. For example, the indication 220 may indicated an index of a table associated with a desired mapping. Based on the indicated table and the aggregation level at the UE 115-a, the UE 115-a may determine the quantity of blind decoding candidates. The UE 115-a may monitor for control channels 225 (e.g., PDCCH) based on the indicated quantity, and may receive control channels 225 based on the monitoring.

FIG. 3 shows an example of a CCE diagram 300 that supports dynamic indication of blind decoding candidates for aggregation levels in accordance with one or more aspects of the present disclosure. The CCE diagram 300 may implement, or be implemented by, aspects of the wireless communications systems 100 or 200. The techniques described herein in the context of the wireless communications system 200 may support a network entity dynamically indicating a change in a quantity of PDCCH blind decoding candidates to increase successful CCE allocation between UEs.

In some implementations, an increased quantity of PDCCH blind decoding candidates may increase a rate of successful CCE allocation. That is, the greater a quantity of PDCCH blind decoding candidates for a UE, the more likely that the UE may successfully receive a PDCCH. For example, network CCEs 305 may include busy CCEs 310 and empty CCEs 315. The busy CCEs 310 may be CCEs that may be scheduled or used for UEs other than a target UE. The target UE may maintain UE CCE positions 320, which may be the valid, or available, CCE positions that the UE may monitor for a PDCCH. The UE CCE positions 320 may include UE-monitored CCEs 325 and empty CCEs 315 (e.g., un-monitored CCEs). If the UE monitors UE-monitored CCEs 325 that overlap with busy CCEs 310, the UE may not receive a PDCCH in the UE-monitored CCEs 325 and the CCE allocation may be unsuccessful (e.g., failed CCE allocation). If the UE monitors at multiple UE CCE positions 320, the UE may be more likely to monitor relevant network CCEs 305, such as empty CCEs 315 (e.g., network CCEs 305 that may not be busy).

In some implementations, an aggregation level may indicate the quantity of CCEs for transmitting a DCI (e.g., a PDCCH may include that quantity of CCEs). For example, for an aggregation level of eight (e.g., AggLev8), a network entity may use eight CCEs to transmit a DCI. In order to receive the DCI, a UE may monitor eight UE-monitored CCEs 325, which may form a PDCCH blind decoding candidate. If any of the UE-monitored CCEs 325 for a PDCCH blind decoding candidate conflict or overlap with busy CCEs 310, the UE may fail to receive a PDCCH during the monitoring occasion. That is, CCE allocation may be deemed unsuccessful or a failure. However, the UE may monitor at multiple UE CCE positions 320, or multiple PDCCH blind decoding candidates. By increasing a quantity of PDCCH blind decoding candidates, the UE may be more likely to successfully receive a PDCCH.

In order to support multiple blind decoding candidates, the network entity may configure a UE with a quantity of PDCCH blind decoding candidates (e.g., n0, n1, n2, n4, or the like) corresponding to an aggregation level (e.g., AggLev1, AggLev2, AggLev4, AggLev8, AggLev16, and the like). The configuration may be transmitted or indicated via control signaling (e.g., RRC signaling). The aggregation level of the UE may be configured by the network entity, indicated to the UE by a network entity, pre-configured, or any combination thereof. In some cases, the aggregation level may correspond to conditions at the UE. For example, a UE farther from the network entity, such as a UE in the far cell, may implement a higher aggregation level to support a lower coding rate. That is, transmissions to a far cell UE may have a low coding rate, or more redundant bits to information bits, in order to increase the likelihood of successful decoding at the UE. However, to support the low coding rate, the UE may implement a high aggregation level, using a greater quantity of CCEs for receiving a PDCCH.

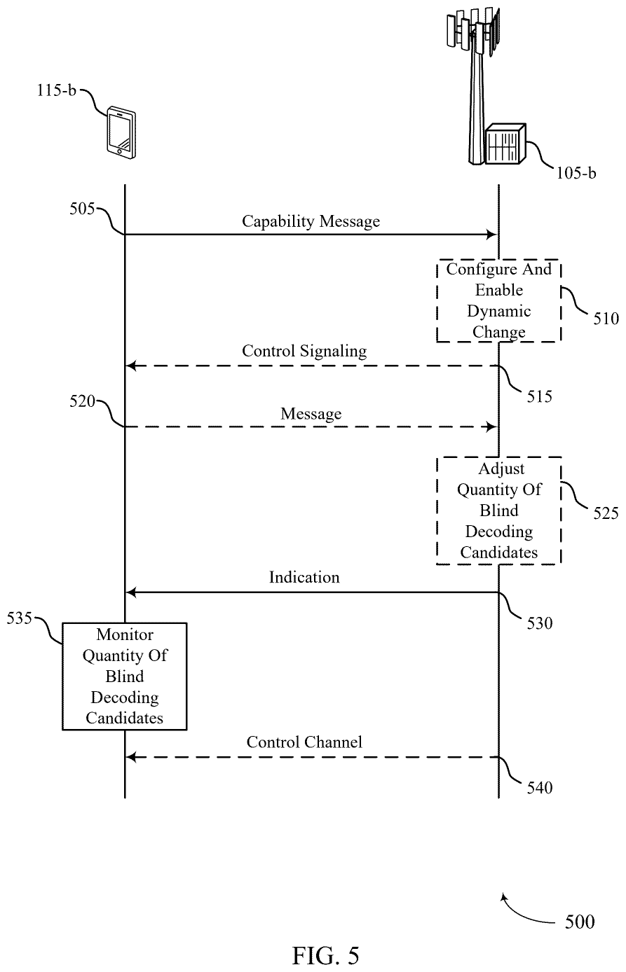

In some implementations, conditions at the UE may change. For example, the UE may change locations or speed in a cell, the UE may change aggregation levels, a network load may change, a reliability threshold may be introduced for an application, a quality of service metric may be introduced for an application, or other metrics may change or apply. It may be beneficial to adjust the quantity of blind decoding candidates at the UE to support these changes. For example, if a UE moves from a far cell to a near cell, the quantity of blind decoding candidates for an indicated aggregation level may decrease. That is, the UE may monitor large chunks of CCEs based on the aggregation level. If the UE moves to the near cell, the network entity may transmit PDCCHs with fewer CCEs than indicated by an aggregation level, so the UE may not monitor as many PDCCH blind decoding candidates as in the far cell for a high aggregation level. Additionally, or alternatively, the aggregation level of the UE may change when moving to the near cell, and the UE may expend greater quantities of PDCCH blind decoding candidates for lower aggregation levels in the near cell. To indicate the change, the network entity may transmit a DCI or MAC-CE indicating to change the quantity of PDCCH blind decoding candidates at the UE, as described further with reference to FIGS. 2 and 5.

FIGS. 4A and 4B show examples of blind decoding candidate mappings 400 and 401, respectively, that support dynamic indication of blind decoding candidates for aggregation levels in accordance with one or more aspects of the present disclosure. The blind decoding candidate mappings 400 and 401 may implement, or be implemented by, aspects of the wireless communications systems 100 and 200, and the CCE diagram 300. The techniques described herein in the context of the blind decoding candidate mappings 400 and 401 may support a network entity dynamically indicating a change in a quantity of PDCCH blind decoding candidates by indicating mappings of the blind decoding candidate mappings 400 and 401.

As described with reference to FIG. 2, a network entity may configure a UE with multiple mappings, or tables, between aggregation levels and PDCCH candidates, as shown in blind decoding candidate mappings 400. In some cases, the mappings may indicate the quantity of PDCCH blind decoding candidates for an aggregation level for each slot of a pattern (e.g., TDD pattern), as described with reference to blind decoding candidate mappings 401.

With respect to blind decoding candidate mappings 400, the network entity may configure the UE with multiple mappings or tables (e.g., eight tables), such as table 405 and 410. The tables may indicate a quantity of candidates for PDCCH blind decoding based on an aggregation level. Depending on conditions at the UE, a mapping of the multiple mappings may indicate a better quantity of PDCCH blind decoding candidates than other mappings of the multiple mappings. For example, a UE in a far cell may have a higher aggregation level and thus may be associated with a table 410, such that a greater quantity of PDCCH blind decoding candidates are mapped to higher aggregation levels. In order to indicate which mapping to use, the network entity may transmit an indication of an index associated with the table 410, which may indicate to the UE to use the table 410 and the quantity of PDCCH blin d decoding candidates associated with the aggregation level of the UE indicated in the table 410. If the UE moves into the near cell, the network entity may transmit an indication of the table 405, which may support higher quantities of PDCCH blind decoding candidates for lower aggregation levels. In this way, the network entity may dynamically indicate a change in a quantity of PDCCH blind decoding candidates to the UE. In some cases, the UE may indicate a mapping or table (e.g., preferred mapping, preferred table). For example, a far cell UE may send a message to the network entity indicating table 410. In some examples, the network entity may indicate to use Table 410 based on the message from the UE.

With respect to blind decoding candidate mappings 401, the multiple mappings, or tables, may indicate quantities of PDCCH candidates for each slot of a pattern (e.g., TDD slot pattern), such as in tables 415 and 420. This may support variations in a type of slot, such as uplink, downlink, or switching slots, across the pattern, as described further with reference to FIG. 2. For example, slot eight of a pattern may be an uplink slot, where the UE may not receive any DCI, and thus may have no PDCCH blind decoding candidates allocated to it in the tables 415 and 420. The multiple mappings may also support changes in aggregation level or position of the UE, similarly to blind decoding candidate mappings 400. For example, table 420 may allocate greater quantities of blind decoding candidates to higher aggregation levels, and may be more desirable for a far cell UE. The network entity may indicate a table using an index associated with the table, and the UE may indicate a table, as described further with reference to blind decoding candidate mappings 400 and with reference to FIG. 5.

FIG. 5 shows an example of a process flow 500 that supports dynamic indication of blind decoding candidates for aggregation levels in accordance with one or more aspects of the present disclosure. The process flow 500 may implement, or be implemented by, aspects of the wireless communications systems 100 and 200, the CCE diagram 300, and blind decoding candidate mappings 400 and 401. For example, the wireless communications system 200 may include one or more network entities 105 and UEs 115, including at least the network entity 105-b and the UE 115-b, which may be examples of corresponding devices as described herein, including with reference to FIGS. 1 and 2. The techniques described herein in the context of the process flow 500 may support the network entity 105-b dynamically indicating a change in a quantity of PDCCH blind decoding candidates based on an indicated capability of the UE 115-b.

At 505, the UE 115-b may transmit, and the network entity 105-b may obtain, a capability message that may indicate a capability of the UE 115-b to support dynamic change of control channel blind decoding candidates (e.g., PDCCH blind decoding candidates). That is, the UE 115-b may indicate support of a dynamic PDCCH blind decoding candidate indication, as described further at 530.

In some implementations, at 510, the network entity 105-b may configure and enable dynamic change of control channel blind decoding candidates based on the capability of the UE 115-b, as described at 505.

In some implementations, at 515, the UE 115-b may receive, and the network entity 105-b may output, control signaling that may indicate one or more mappings, the one or more mappings including a mapping associated with the indication, where the mapping associated with the indication may map the quantity of control channel blind decoding candidates with an aggregation level associated with the slot position, where the slot position in the frame may be in accordance with a TDD pattern. In some cases, the control signaling may be an example of RRC signaling, which may include an RRC configuration (e.g., RRC reconfiguration). The RRC configuration may be an information element. In other cases, the control signaling may include a MAC-CE or DCI message, where bits in the MAC-CE or DCI may indicate a change or adjustment to PDCCH blind decoding candidates for each aggregation level that the UE 115-b may support. In some cases, the one or more mappings may include one or more tables, as described further with reference to FIGS. 4A and 4B. The one or more tables may map quantities of control channel blind decoding candidates to aggregation levels. In some cases, the one or more tables may also indicate quantities of control channel blind decoding candidates for each slot (e.g., TDD slot) of a pattern. Each table of the one or more tables may be associated with an index.

In some implementations, at 520, the UE 115-b may transmit, and the network entity 105-b may obtain, a message indicating a UE-preferred mapping of the one or more mappings, as described at 515, where receiving the indication is based on transmitting the message. That is, the UE 115-b may transmit the message indicating a UE-preferred mapping (e.g., the mapping) of the one or more mappings. In some cases, the message may be transmitted via control signaling (e.g., RRC signaling), a MAC-CE, or channel state information (CSI).

In some implementations, at 525, the network entity 105-b may adjust the quantity of control channel blind decoding candidates. In some cases, the network entity 105-b may determine or adjust the quantity of control channel blind decoding candidates based on a radio frequency condition, a network load, mobility of the UE 115-b, network energy saving procedures, application thresholds, or any combination thereof.

At 530, the UE 115-b may receive, and the network entity 105-b may obtain, an indication that a quantity of control channel blind decoding candidates in a slot to be monitored by the UE may be changed, where the slot may have a slot position in a frame, the indication may be based on the slot position, and receiving the indication may be in accordance with the capability message, as described at 505. In some implementations, the UE 115-b may determine the quantity of control channel blind decoding candidates in accordance with the indication and based on an aggregation level associated with communication via the one or more control channels. That is, the indication, combined with an aggregation level associated with communication via the one or more control channels, may be indicative of the quantity of control channel blind decoding candidates. In some cases, determination of the quantity of control channel blind decoding candidates may be based on a slot associated with the aggregation level and the communication via the one or more control channels. That is, the indication, further combined with a slot associated with the aggregation level and the communication via the one or more control channels, may be indicative of the quantity of control channel blind decoding candidates. In some cases, determination of the quantity of control channel blind decoding candidates may be further based on a TDD pattern associated with the aggregation level and the communication via the one or more control channels. In some cases, determination of the quantity of control channel blind decoding candidates may be further based on a SBFD pattern associated with the aggregation level and the communication via the one or more control channels. In some cases, determination of the quantity of control channel blind decoding candidates may be further based on a TN slot pattern or an NTN slot pattern associated with the aggregation level and the communication via the one or more control channels.

In some cases, the indication may include an index of the mapping of the one or more mappings, as described at 515. In some cases, the indication may be based on one or more conditions associated with a serving cell, the one or more conditions including a distance of the UE from a network entity of the serving cell, a network load, a speed of the UE within the serving cell, a quality of service threshold, a reliability threshold, or any combination thereof. In some cases, the indication may be received in a MAC-CE or a DCI message. In some cases, the indication may dynamically overwrite a static, or default, configuration of a quantity of control channel blind decoding candidates indicated by control signaling (e.g., RRC signaling). In some cases, the UE 115-b may implement the indicated quantity of control channel blind decoding candidates may after some duration (e.g., 3 ms).

At 535, the UE 115-b may monitor, in the slot in accordance with the indication, as described at 530, the quantity of control channel blind decoding candidates for one or more control channels (e.g., PDCCH). That is, the UE 115-b may expend control channel blind decode attempts within downlink slots based on the indication, as described at 530, which may reduce PDCCH blocking and improve performance at the UE 115-b.

In some implementations, at 540, the UE 115-b may receive, and the network entity may output, the one or more control channels, the one or more control channels associated with the quantity of control channel blind decoding candidates. In some cases, the network entity 105-b may output the one or more control channels in accordance with the indication, as described at 530. In some cases, the UE 115-b may receive the one or more control channels in accordance with monitoring the quantity of control channel blind decoding candidates, as described at 535.

In some implementations, the indication, as described at 530 may be a first indication. The UE 115-b may receive, and the network entity 105-b may output, a second indication that the quantity of control channel blind decoding candidates in a second slot to be monitored by the UE is changed to a second quantity of control channel blind decoding candidates, where the second slot has a second slot position in a frame and where the second indication is based on the second slot position. The UE 115-b may monitor, in the second slot and in accordance with the second indication, the second quantity of control channel blind decoding candidates for one or more second control channels. In some cases, the UE 115-b may receive, and the network entity 105-b may output, in accordance with the second indication, one or more second control channels, the one or more second control channels associated with the second quantity of control channel blind decoding candidates.

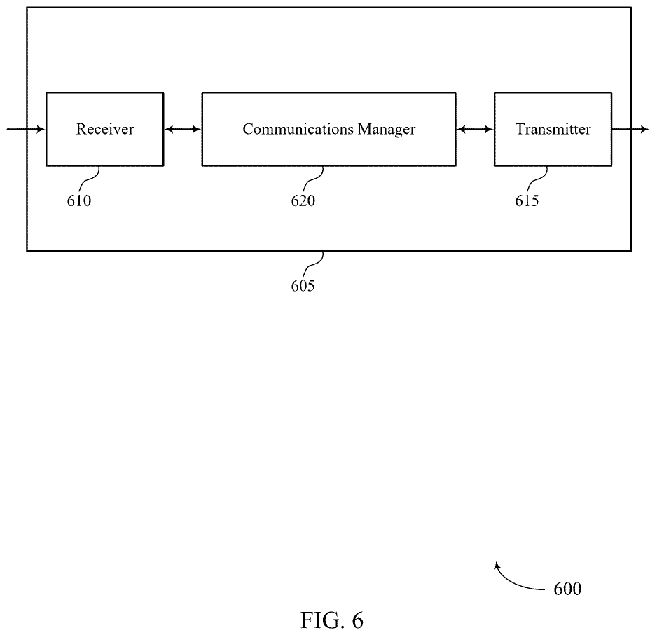

FIG. 6 shows a block diagram 600 of a device 605 that supports dynamic indication of blind decoding candidates for aggregation levels in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dynamic indication of blind decoding candidates for aggregation levels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dynamic indication of blind decoding candidates for aggregation levels). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of dynamic indication of blind decoding candidates for aggregation levels as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting a capability message that indicates a capability of the UE to support dynamic change of control channel blind decoding candidates. The communications manager 620 is capable of, configured to, or operable to support a means for receiving, in accordance with the capability message, an indication that a quantity of control channel blind decoding candidates in a slot to be monitored by the UE is changed, where the slot has a slot position in a frame and where the indication is based on the slot position. The communications manager 620 is capable of, configured to, or operable to support a means for monitoring, in the slot and in accordance with the indication, the quantity of control channel blind decoding candidates for one or more control channels.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced latency, reduced PDCCH blocking, and more efficient utilization of communication resources.

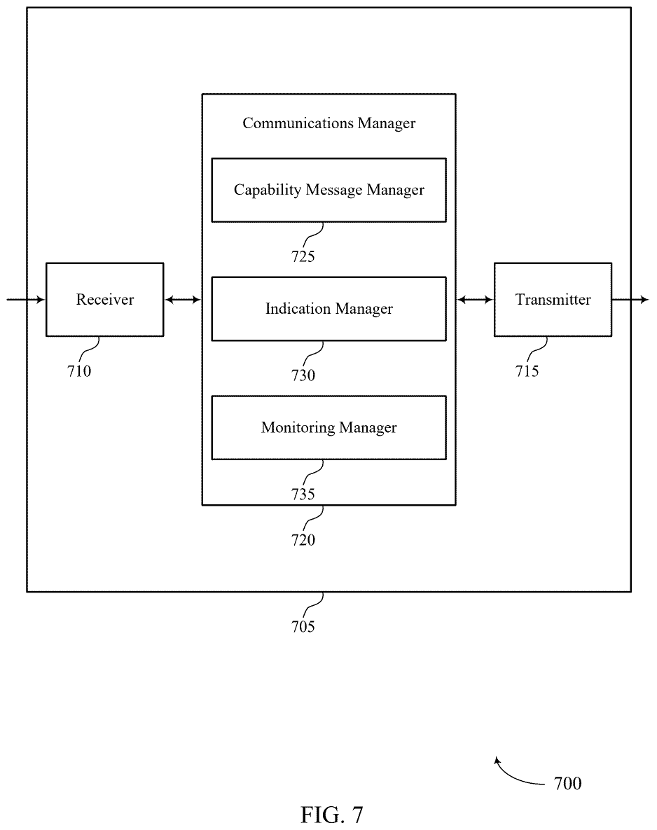

FIG. 7 shows a block diagram 700 of a device 705 that supports dynamic indication of blind decoding candidates for aggregation levels in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to dynamic indication of blind decoding candidates for aggregation levels). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to dynamic indication of blind decoding candidates for aggregation levels). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of dynamic indication of blind decoding candidates for aggregation levels as described herein. For example, the communications manager 720 may include a capability message manager 725, an indication manager 730, a monitoring manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The capability message manager 725 is capable of, configured to, or operable to support a means for transmitting a capability message that indicates a capability of the UE to support dynamic change of control channel blind decoding candidates. The indication manager 730 is capable of, configured to, or operable to support a means for receiving, in accordance with the capability message, an indication that a quantity of control channel blind decoding candidates in a slot to be monitored by the UE is changed, where the slot has a slot position in a frame and where the indication is based on the slot position. The monitoring manager 735 is capable of, configured to, or operable to support a means for monitoring, in the slot and in accordance with the indication, the quantity of control channel blind decoding candidates for one or more control channels.

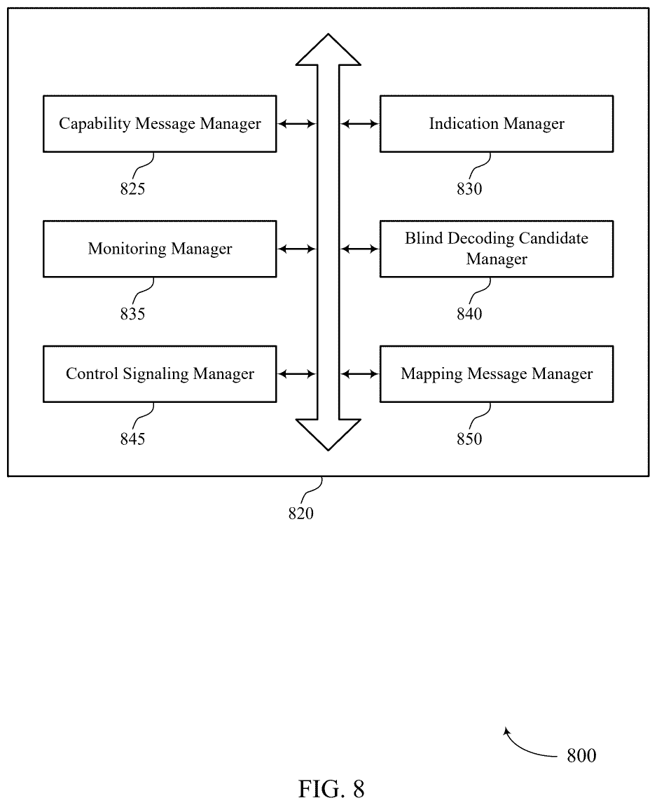

FIG. 8 shows a block diagram 800 of a communications manager 820 that supports dynamic indication of blind decoding candidates for aggregation levels in accordance with one or more aspects of the present disclosure. The communications manager 820 may be an example of aspects of a communications manager 620, a communications manager 720, or both, as described herein. The communications manager 820, or various components thereof, may be an example of means for performing various aspects of dynamic indication of blind decoding candidates for aggregation levels as described herein. For example, the communications manager 820 may include a capability message manager 825, an indication manager 830, a monitoring manager 835, a blind decoding candidate manager 840, a control signaling manager 845, a mapping message manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The capability message manager 825 is capable of, configured to, or operable to support a means for transmitting a capability message that indicates a capability of the UE to support dynamic change of control channel blind decoding candidates. The indication manager 830 is capable of, configured to, or operable to support a means for receiving, in accordance with the capability message, an indication that a quantity of control channel blind decoding candidates in a slot to be monitored by the UE is changed, where the slot has a slot position in a frame and where the indication is based on the slot position. The monitoring manager 835 is capable of, configured to, or operable to support a means for monitoring, in the slot and in accordance with the indication, the quantity of control channel blind decoding candidates for one or more control channels.

In some examples, the blind decoding candidate manager 840 is capable of, configured to, or operable to support a means for determining the quantity of control channel blind decoding candidates in accordance with the indication and based on an aggregation level associated with communication via the one or more control channels.

In some examples, determination of the quantity of control channel blind decoding candidates is further based on a slot associated with the aggregation level and the communication via the one or more control channels.

In some examples, determination of the quantity of control channel blind decoding candidates is further based on a TDD pattern associated with the aggregation level and the communication via the one or more control channels.

In some examples, determination of the quantity of control channel blind decoding candidates is further based on a SBFD pattern associated with the aggregation level and the communication via the one or more control channels.

In some examples, determination of the quantity of control channel blind decoding candidates is further based on a TN slot pattern or a NTN slot pattern associated with the aggregation level and the communication via the one or more control channels.

In some examples, the control signaling manager 845 is capable of, configured to, or operable to support a means for receiving control signaling that indicates one or more mappings, the one or more mappings including a mapping associated with the indication, where the mapping associated with the indication maps the quantity of control channel blind decoding candidates with an aggregation level associated with the slot position, where the slot position in the frame is in accordance with a TDD pattern.

In some examples, the mapping message manager 850 is capable of, configured to, or operable to support a means for transmitting a message indicating a UE-preferred mapping of the one or more mappings, where receiving the indication is based on transmitting the message.

In some examples, the indication includes an index of the mapping of the one or more mappings.

In some examples, the indication is based on one or more conditions associated with a serving cell, the one or more conditions including a distance of the UE from a network entity of the serving cell, a network load, a speed of the UE within the serving cell, a quality of service threshold, a reliability threshold, or any combination thereof.

In some examples, the indication is received in a MAC-CE or a DCI message.

In some examples, the indication is a first indication, and the indication manager 830 is capable of, configured to, or operable to support a means for receiving a second indication that the quantity of control channel blind decoding candidates in a second slot to be monitored by the UE is changed to a second quantity of control channel blind decoding candidates, where the second slot has a second slot position in a frame and where the second indication is based on the second slot position. In some examples, the indication is a first indication, and the monitoring manager 835 is capable of, configured to, or operable to support a means for monitoring, in the second slot and in accordance with the second indication, the second quantity of control channel blind decoding candidates for one or more second control channels.

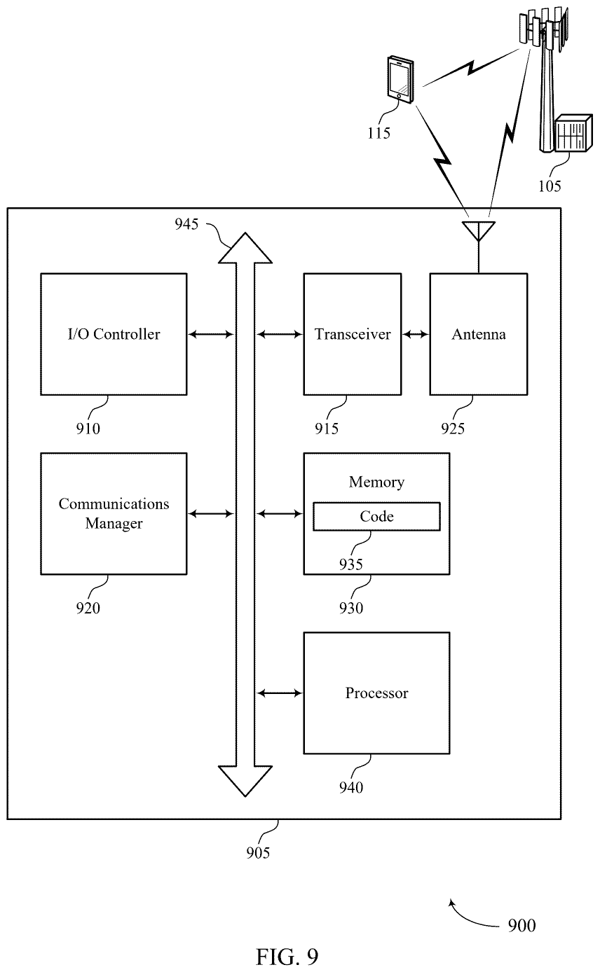

FIG. 9 shows a diagram of a system 900 including a device 905 that supports dynamic indication of blind decoding candidates for aggregation levels in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting dynamic indication of blind decoding candidates for aggregation levels). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting a capability message that indicates a capability of the UE to support dynamic change of control channel blind decoding candidates. The communications manager 920 is capable of, configured to, or operable to support a means for receiving, in accordance with the capability message, an indication that a quantity of control channel blind decoding candidates in a slot to be monitored by the UE is changed, where the slot has a slot position in a frame and where the indication is based on the slot position. The communications manager 920 is capable of, configured to, or operable to support a means for monitoring, in the slot and in accordance with the indication, the quantity of control channel blind decoding candidates for one or more control channels.

By including or configuring the communications manager 920 in accordance with examples as described herein, the device 905 may support techniques for improved communication reliability, reduced latency, reduced PDCCH blocking, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of dynamic indication of blind decoding candidates for aggregation levels as described herein, or the at least one processor 940 and the at least one memory 930 may be otherwise configured to, individually or collectively, perform or support such operations.

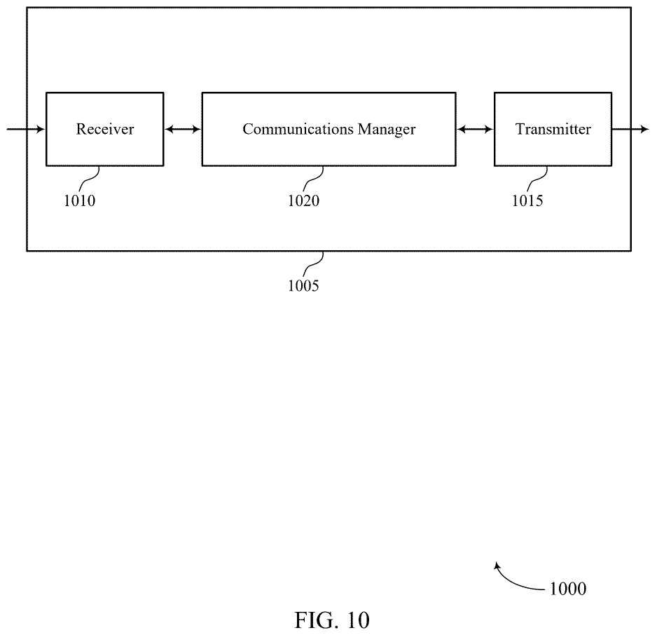

FIG. 10 shows a block diagram 1000 of a device 1005 that supports dynamic indication of blind decoding candidates for aggregation levels in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of dynamic indication of blind decoding candidates for aggregation levels as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for obtaining a capability message that indicates a capability of a UE to support dynamic change of control channel blind decoding candidates. The communications manager 1020 is capable of, configured to, or operable to support a means for outputting, in accordance with the capability message, an indication that a quantity of control channel blind decoding candidates in a slot to be monitored by the UE is changed, where the slot has a slot position in a frame and where the indication is based on the slot position. The communications manager 1020 is capable of, configured to, or operable to support a means for outputting, in the slot and in accordance with the indication, the quantity of control channel blind decoding candidates for one or more control channels.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced latency, reduced PDCCH blocking, and more efficient utilization of communication resources.

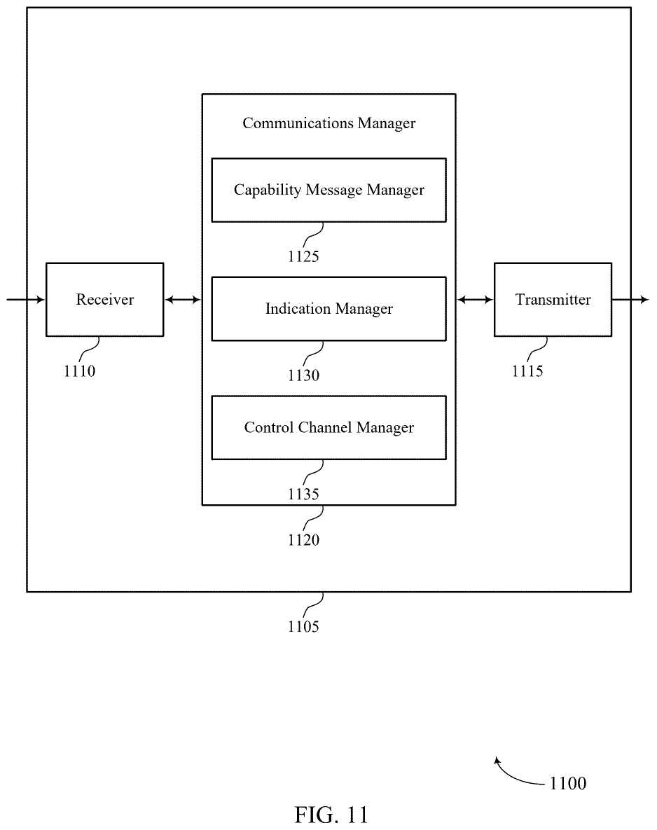

FIG. 11 shows a block diagram 1100 of a device 1105 that supports dynamic indication of blind decoding candidates for aggregation levels in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of dynamic indication of blind decoding candidates for aggregation levels as described herein. For example, the communications manager 1120 may include a capability message manager 1125, an indication manager 1130, a control channel manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The capability message manager 1125 is capable of, configured to, or operable to support a means for obtaining a capability message that indicates a capability of a UE to support dynamic change of control channel blind decoding candidates. The indication manager 1130 is capable of, configured to, or operable to support a means for outputting, in accordance with the capability message, an indication that a quantity of control channel blind decoding candidates in a slot to be monitored by the UE is changed, where the slot has a slot position in a frame and where the indication is based on the slot position. The control channel manager 1135 is capable of, configured to, or operable to support a means for outputting, in the slot and in accordance with the indication, the quantity of control channel blind decoding candidates for one or more control channels.

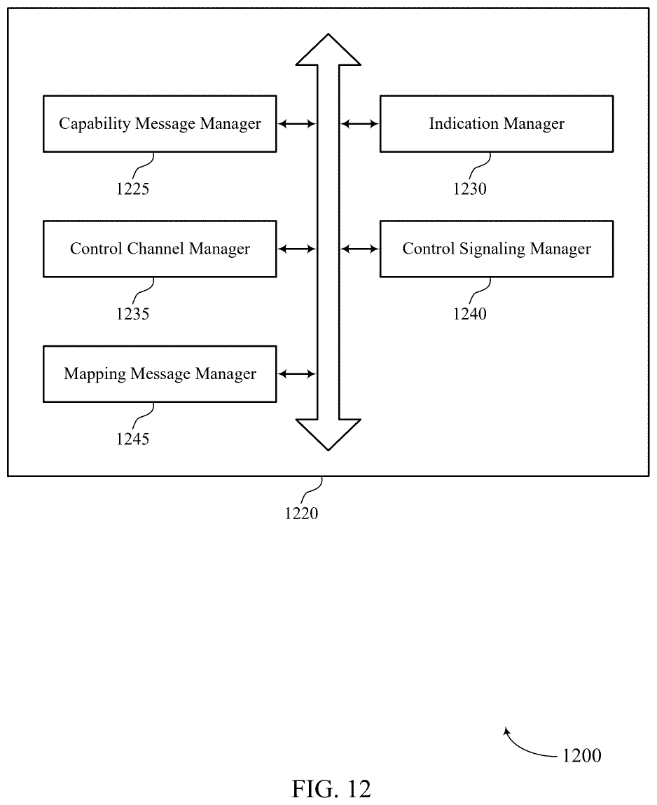

FIG. 12 shows a block diagram 1200 of a communications manager 1220 that supports dynamic indication of blind decoding candidates for aggregation levels in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of dynamic indication of blind decoding candidates for aggregation levels as described herein. For example, the communications manager 1220 may include a capability message manager 1225, an indication manager 1230, a control channel manager 1235, a control signaling manager 1240, a mapping message manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The capability message manager 1225 is capable of, configured to, or operable to support a means for obtaining a capability message that indicates a capability of a UE to support dynamic change of control channel blind decoding candidates. The indication manager 1230 is capable of, configured to, or operable to support a means for outputting, in accordance with the capability message, an indication that a quantity of control channel blind decoding candidates in a slot to be monitored by the UE is changed, where the slot has a slot position in a frame and where the indication is based on the slot position. The control channel manager 1235 is capable of, configured to, or operable to support a means for outputting, in the slot and in accordance with the indication, the quantity of control channel blind decoding candidates for one or more control channels.

In some examples, the indication, combined with an aggregation level associated with communication via the one or more control channels, is indicative of the quantity of control channel blind decoding candidates.

In some examples, the indication, further combined with a slot associated with the aggregation level, a TDD pattern associated with the aggregation level, a SBFD pattern associated with the aggregation level, a TN slot pattern associated with the aggregation level, a NTN slot pattern associated with the aggregation level, or any combination thereof and the communication via the one or more control channels, is indicative of the quantity of control channel blind decoding candidates.

In some examples, the control signaling manager 1240 is capable of, configured to, or operable to support a means for outputting control signaling that indicates one or more mappings, the one or more mappings including a mapping associated with the indication, where the mapping associated with the indication maps the quantity of control channel blind decoding candidates with an aggregation level associated with the slot position, where the slot position in the frame is in accordance with a TDD pattern.

In some examples, the mapping message manager 1245 is capable of, configured to, or operable to support a means for obtaining a message indicating a UE-preferred mapping of the one or more mappings, where receiving the indication is based on transmitting the message.

In some examples, the indication includes an index of the mapping of the one or more mappings.

In some examples, the indication is based on one or more conditions associated with a serving cell that includes the network entity, the one or more conditions including a distance of the UE from the network entity, a network load, a speed of the UE within the serving cell, a quality of service threshold, a reliability threshold, or any combination thereof.

In some examples, the indication is output in a MAC-CE or a DCI message.

In some examples, the indication is a first indication, and the indication manager 1230 is capable of, configured to, or operable to support a means for outputting a second indication that the quantity of control channel blind decoding candidates in a second slot to be monitored by the UE is changed to a second quantity of control channel blind decoding candidates, where the second slot has a second slot position in a frame and where the second indication is based on the second slot position. In some examples, the indication is a first indication, and the control channel manager 1235 is capable of, configured to, or operable to support a means for outputting, in the second slot and in accordance with the second indication, one or more second control channels, the one or more second control channels associated with the second quantity of control channel blind decoding candidates.

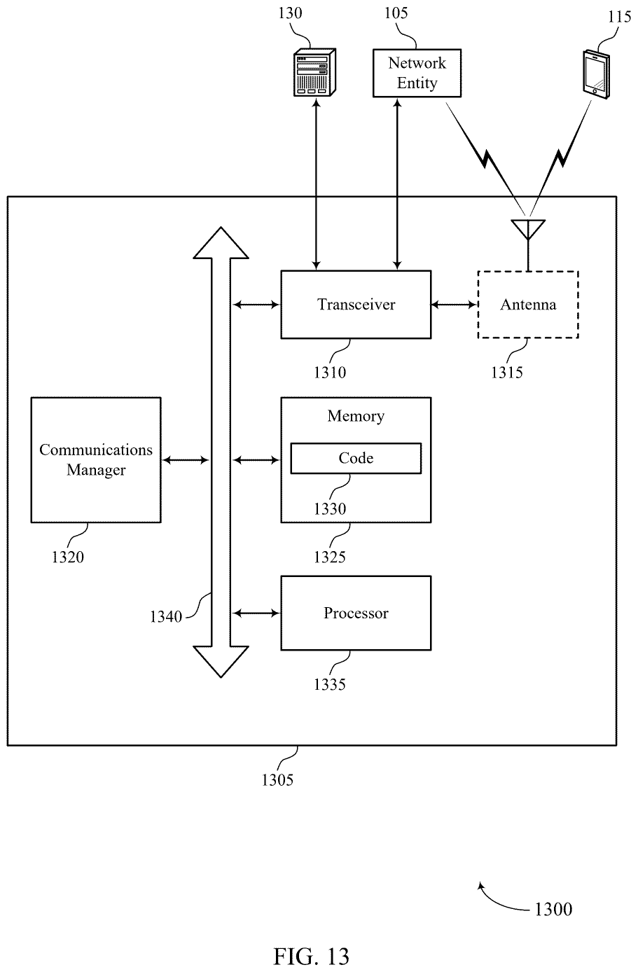

FIG. 13 shows a diagram of a system 1300 including a device 1305 that supports dynamic indication of blind decoding candidates for aggregation levels in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting dynamic indication of blind decoding candidates for aggregation levels). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for obtaining a capability message that indicates a capability of a UE to support dynamic change of control channel blind decoding candidates. The communications manager 1320 is capable of, configured to, or operable to support a means for outputting, in accordance with the capability message, an indication that a quantity of control channel blind decoding candidates in a slot to be monitored by the UE is changed, where the slot has a slot position in a frame and where the indication is based on the slot position. The communications manager 1320 is capable of, configured to, or operable to support a means for outputting, in the slot and in accordance with the indication, the quantity of control channel blind decoding candidates for one or more control channels.

By including or configuring the communications manager 1320 in accordance with examples as described herein, the device 1305 may support techniques for improved communication reliability, reduced latency, reduced PDCCH blocking, more efficient utilization of communication resources, improved coordination between devices, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of dynamic indication of blind decoding candidates for aggregation levels as described herein, or the at least one processor 1335 and the at least one memory 1325 may be otherwise configured to, individually or collectively, perform or support such operations.

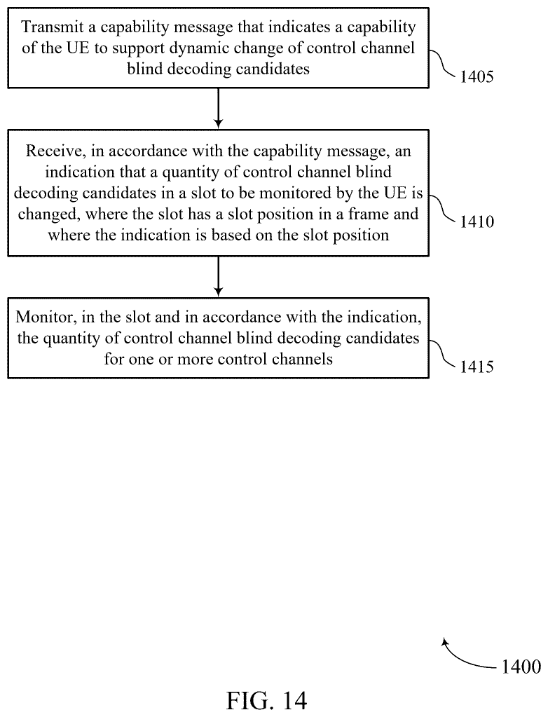

FIG. 14 shows a flowchart illustrating a method 1400 that supports dynamic indication of blind decoding candidates for aggregation levels in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message that indicates a capability of the UE to support dynamic change of control channel blind decoding candidates. The operations of 1405 may be performed in accordance with examples as disclosed herein. In some examples, aspects of the operations of 1405 may be performed by a capability message manager 825 as described with reference to FIG. 8.

At 1410, the method may include receiving, in accordance with the capability message, an indication that a quantity of control channel blind decoding candidates in a slot to be monitored by the UE is changed, where the slot has a slot position in a frame and where the indication is based on the slot position. The operations of 1410 may be performed in accordance with examples as disclosed herein. In some examples, aspects of the operations of 1410 may be performed by an indication manager 830 as described with reference to FIG. 8.

At 1415, the method may include monitoring, in the slot and in accordance with the indication, the quantity of control channel blind decoding candidates for one or more control channels. The operations of 1415 may be performed in accordance with examples as disclosed herein. In some examples, aspects of the operations of 1415 may be performed by a monitoring manager 835 as described with reference to FIG. 8.

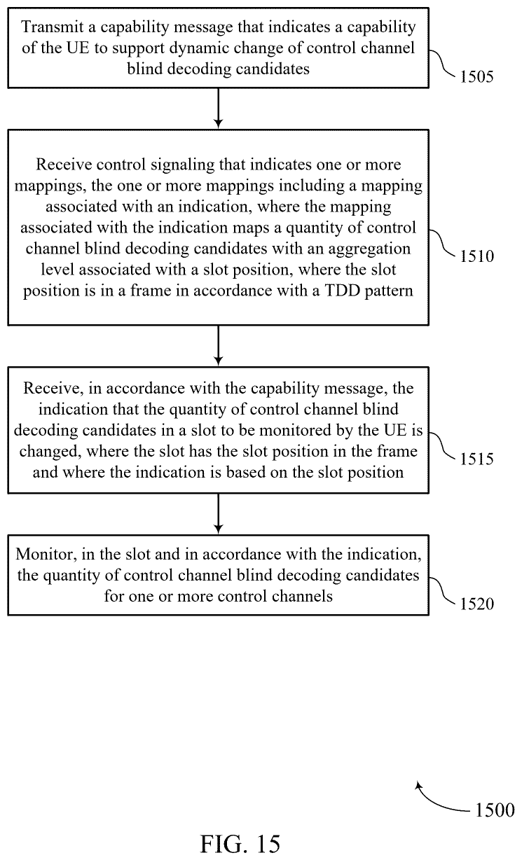

FIG. 15 shows a flowchart illustrating a method 1500 that supports dynamic indication of blind decoding candidates for aggregation levels in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message that indicates a capability of the UE to support dynamic change of control channel blind decoding candidates. The operations of 1505 may be performed in accordance with examples as disclosed herein. In some examples, aspects of the operations of 1505 may be performed by a capability message manager 825 as described with reference to FIG. 8.

At 1510, the method may include receiving control signaling that indicates one or more mappings, the one or more mappings including a mapping associated with an indication, where the mapping associated with the indication maps a quantity of control channel blind decoding candidates with an aggregation level associated with a slot position, where the slot position is in a frame in accordance with a TDD pattern. The operations of 1510 may be performed in accordance with examples as disclosed herein. In some examples, aspects of the operations of 1510 may be performed by a control signaling manager 845 as described with reference to FIG. 8.

At 1515, the method may include receiving, in accordance with the capability message, the indication that the quantity of control channel blind decoding candidates in a slot to be monitored by the UE is changed, where the slot has the slot position in the frame and where the indication is based on the slot position. The operations of 1515 may be performed in accordance with examples as disclosed herein. In some examples, aspects of the operations of 1515 may be performed by an indication manager 830 as described with reference to FIG. 8.

At 1520, the method may include monitoring, in the slot and in accordance with the indication, the quantity of control channel blind decoding candidates for one or more control channels. The operations of 1520 may be performed in accordance with examples as disclosed herein. In some examples, aspects of the operations of 1520 may be performed by a monitoring manager 835 as described with reference to FIG. 8.

The following provides an overview of aspects of the present disclosure:

Aspect 1: A method for wireless communications at a UE, comprising: transmitting a capability message that indicates a capability of the UE to support dynamic change of control channel blind decoding candidates; receiving, in accordance with the capability message, an indication that a quantity of control channel blind decoding candidates in a slot to be monitored by the UE is changed, wherein the slot has a slot position in a frame and wherein the indication is based at least in part on the slot position; and monitoring, in the slot and in accordance with the indication, the quantity of control channel blind decoding candidates for one or more control channels.

Aspect 2: The method of aspect 1, further comprising: determining the quantity of control channel blind decoding candidates in accordance with the indication and based at least in part on an aggregation level associated with communication via the one or more control channels.

Aspect 3: The method of aspect 2, wherein determination of the quantity of control channel blind decoding candidates is further based at least in part on a slot associated with the aggregation level and the communication via the one or more control channels.

Aspect 4: The method of any of aspects 2 through 3, wherein determination of the quantity of control channel blind decoding candidates is further based at least in part on a TDD pattern associated with the aggregation level and the communication via the one or more control channels.

Aspect 5: The method of any of aspects 2 through 4, wherein determination of the quantity of control channel blind decoding candidates is further based at least in part on a SBFD pattern associated with the aggregation level and the communication via the one or more control channels.

Aspect 6: The method of any of aspects 2 through 5, wherein determination of the quantity of control channel blind decoding candidates is further based at least in part on a TN slot pattern or a NTN slot pattern associated with the aggregation level and the communication via the one or more control channels.

Aspect 7: The method of any of aspects 1 through 6, further comprising: receiving control signaling that indicates one or more mappings, the one or more mappings comprising a mapping associated with the indication, wherein the mapping associated with the indication maps the quantity of control channel blind decoding candidates with an aggregation level associated with the slot position, wherein the slot position in the frame is in accordance with a TDD pattern.

Aspect 8: The method of aspect 7, further comprising: transmitting a message indicating a UE-preferred mapping of the one or more mappings, wherein receiving the indication is based at least in part on transmitting the message.

Aspect 9: The method of any of aspects 7 through 8, wherein the indication comprises an index of the mapping of the one or more mappings.

Aspect 10: The method of any of aspects 1 through 9, wherein the indication is based at least in part on one or more conditions associated with a serving cell, the one or more conditions comprising a distance of the UE from a network entity of the serving cell, a network load, a speed of the UE within the serving cell, a quality of service threshold, a reliability threshold, or any combination thereof.

Aspect 11: The method of any of aspects 1 through 10, wherein the indication is received in a MAC-CE or a DCI message.

Aspect 12: The method of any of aspects 1 through 11, wherein the indication is a first indication, the method further comprising: receiving a second indication that the quantity of control channel blind decoding candidates in a second slot to be monitored by the UE is changed to a second quantity of control channel blind decoding candidates, wherein the second slot has a second slot position in a frame and wherein the second indication is based at least in part on the second slot position; and monitoring, in the second slot and in accordance with the second indication, the second quantity of control channel blind decoding candidates for one or more second control channels.

Aspect 13: A method for wireless communications at a network entity, comprising: obtaining a capability message that indicates a capability of a UE to support dynamic change of control channel blind decoding candidates; outputting, in accordance with the capability message, an indication that a quantity of control channel blind decoding candidates in a slot to be monitored by the UE is changed, wherein the slot has a slot position in a frame and wherein the indication is based at least in part on the slot position; and outputting, in the slot and in accordance with the indication, the quantity of control channel blind decoding candidates for one or more control channels.

Aspect 14: The method of aspect 13, wherein the indication, combined with an aggregation level associated with communication via the one or more control channels, is indicative of the quantity of control channel blind decoding candidates.

Aspect 15: The method of aspect 14, wherein the indication, further combined with a slot associated with the aggregation level, a TDD pattern associated with the aggregation level, a SBFD pattern associated with the aggregation level, a TN slot pattern associated with the aggregation level, a NTN slot pattern associated with the aggregation level, or any combination thereof and the communication via the one or more control channels, is indicative of the quantity of control channel blind decoding candidates.

Aspect 16: The method of any of aspects 13 through 15, further comprising: outputting control signaling that indicates one or more mappings, the one or more mappings comprising a mapping associated with the indication, wherein the mapping associated with the indication maps the quantity of control channel blind decoding candidates with an aggregation level associated with the slot position, wherein the slot position in the frame is in accordance with a TDD pattern.

Aspect 17: The method of aspect 16, further comprising: obtaining a message indicating a UE-preferred mapping of the one or more mappings, wherein receiving the indication is based at least in part on transmitting the message.

Aspect 18: The method of any of aspects 16 through 17, wherein the indication comprises an index of the mapping of the one or more mappings.

Aspect 19: The method of any of aspects 13 through 18, wherein the indication is based at least in part on one or more conditions associated with a serving cell that includes the network entity, the one or more conditions comprising a distance of the UE from the network entity, a network load, a speed of the UE within the serving cell, a quality of service threshold, a reliability threshold, or any combination thereof.

Aspect 20: The method of any of aspects 13 through 19, wherein the indication is output in a MAC-CE or a DCI message.

Aspect 21: The method of any of aspects 13 through 20, wherein the indication is a first indication, the method further comprising: outputting a second indication that the quantity of control channel blind decoding candidates in a second slot to be monitored by the UE is changed to a second quantity of control channel blind decoding candidates, wherein the second slot has a second slot position in a frame and wherein the second indication is based at least in part on the second slot position; and outputting, in the second slot and in accordance with the second indication, one or more second control channels, the one or more second control channels associated with the second quantity of control channel blind decoding candidates.

Aspect 22: A UE for wireless communications, comprising one or more memories storing processor-executable code, and one or more processors coupled with the one or more memories and individually or collectively operable to execute the code to cause the UE to perform a method of any of aspects 1 through 12.

Aspect 23: A UE for wireless communications, comprising at least one means for performing a method of any of aspects 1 through 12.

Aspect 24: A non-transitory computer-readable medium storing code for wireless communications, the code comprising instructions executable by one or more processors to perform a method of any of aspects 1 through 12.

Aspect 25: A network entity for wireless communications, comprising one or more memories storing processor-executable code, and one or more processors coupled with the one or more memories and individually or collectively operable to execute the code to cause the network entity to perform a method of any of aspects 13 through 21.

Aspect 26: A network entity for wireless communications, comprising at least one means for performing a method of any of aspects 13 through 21.

Aspect 27: A non-transitory computer-readable medium storing code for wireless communications, the code comprising instructions executable by one or more processors to perform a method of any of aspects 13 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability message that indicates a capability of the UE to support dynamic change of control channel blind decoding candidates;
receive, in accordance with the capability message, an indication that a quantity of control channel blind decoding candidates in a slot to be monitored by the UE is changed, wherein the slot has a slot position in a frame and wherein the indication is based at least in part on the slot position; and
monitor, in the slot and in accordance with the indication, the quantity of control channel blind decoding candidates for one or more control channels.

2. The UE of claim 1, wherein the one or more processors are individually or collectively further operable to execute the code to cause the UE to:
determine the quantity of control channel blind decoding candidates in accordance with the indication and based at least in part on an aggregation level associated with communication via the one or more control channels.

3. The UE of claim 2, wherein determination of the quantity of control channel blind decoding candidates is further based at least in part on a slot associated with the aggregation level and the communication via the one or more control channels.

4. The UE of claim 2, wherein determination of the quantity of control channel blind decoding candidates is further based at least in part on a time division duplexing pattern associated with the aggregation level and the communication via the one or more control channels.

5. The UE of claim 2, wherein determination of the quantity of control channel blind decoding candidates is further based at least in part on a sub-band full duplexing pattern associated with the aggregation level and the communication via the one or more control channels.

6. The UE of claim 2, wherein determination of the quantity of control channel blind decoding candidates is further based at least in part on a terrestrial network slot pattern or a non-terrestrial network slot pattern associated with the aggregation level and the communication via the one or more control channels.

7. The UE of claim 1, wherein the one or more processors are individually or collectively further operable to execute the code to cause the UE to:
receive control signaling that indicates one or more mappings, the one or more mappings comprising a mapping associated with the indication, wherein the mapping associated with the indication maps the quantity of control channel blind decoding candidates with an aggregation level associated with the slot position, wherein the slot position in the frame is in accordance with a time division duplexing pattern.

8. The UE of claim 7, wherein the one or more processors are individually or collectively further operable to execute the code to cause the UE to:
transmit a message indicating a UE-preferred mapping of the one or more mappings, wherein receiving the indication is based at least in part on transmitting the message.

9. The UE of claim 7, wherein the indication comprises an index of the mapping of the one or more mappings.

10. The UE of claim 1, wherein the indication is based at least in part on one or more conditions associated with a serving cell, the one or more conditions comprising a distance of the UE from a network entity of the serving cell, a network load, a speed of the UE within the serving cell, a quality of service threshold, a reliability threshold, or any combination thereof.

11. The UE of claim 1, wherein the indication is received in a media access control-control element or a downlink control information message.

12. The UE of claim 1, wherein the indication is a first indication, and the one or more processors are individually or collectively further operable to execute the code to cause the UE to:
receive a second indication that the quantity of control channel blind decoding candidates in a second slot to be monitored by the UE is changed to a second quantity of control channel blind decoding candidates, wherein the second slot has a second slot position in a frame and wherein the second indication is based at least in part on the second slot position; and
monitor, in the second slot and in accordance with the second indication, the second quantity of control channel blind decoding candidates for one or more second control channels.

13. A method for wireless communications at a user equipment (UE), comprising:
transmitting a capability message that indicates a capability of the UE to support dynamic change of control channel blind decoding candidates;
receiving, in accordance with the capability message, an indication that a quantity of control channel blind decoding candidates in a slot to be monitored by the UE is changed, wherein the slot has a slot position in a frame and wherein the indication is based at least in part on the slot position; and
monitoring, in the slot and in accordance with the indication, the quantity of control channel blind decoding candidates for one or more control channels.

14. The method of claim 13, further comprising:
determining the quantity of control channel blind decoding candidates in accordance with the indication and based at least in part on an aggregation level associated with communication via the one or more control channels.

15. The method of claim 14, wherein determination of the quantity of control channel blind decoding candidates is further based at least in part on a slot associated with the aggregation level and the communication via the one or more control channels.

16. The method of claim 14, wherein determination of the quantity of control channel blind decoding candidates is further based at least in part on a time division duplexing pattern, a sub-band full duplexing pattern, or any combination thereof associated with the aggregation level and the communication via the one or more control channels.

17. The method of claim 14, wherein determination of the quantity of control channel blind decoding candidates is further based at least in part on a terrestrial network slot pattern or a non-terrestrial network slot pattern associated with the aggregation level and the communication via the one or more control channels.

18. The method of claim 13, further comprising:
receiving control signaling that indicates one or more mappings, the one or more mappings comprising a mapping associated with the indication, wherein the mapping associated with the indication maps the quantity of control channel blind decoding candidates with an aggregation level associated with the slot position, wherein the slot position in the frame is in accordance with a time division duplexing pattern.

19. The method of claim 18, further comprising:
transmitting a message indicating a UE-preferred mapping of the one or more mappings, wherein receiving the indication is based at least in part on transmitting the message.

20. A non-transitory computer-readable medium storing code for wireless communications, the code comprising instructions executable by one or more processors to:
transmit a capability message that indicates a capability of a user equipment (UE) to support dynamic change of control channel blind decoding candidates;
receive, in accordance with the capability message, an indication that a quantity of control channel blind decoding candidates in a slot to be monitored by the UE is changed, wherein the slot has a slot position in a frame and wherein the indication is based at least in part on the slot position; and
monitor, in the slot and in accordance with the indication, the quantity of control channel blind decoding candidates for one or more control channels.
